(19) United States
(12) Patent Application Publication
(10) Pub. No.: US 2009/0125270 A1
(43) Pub. Date: May 14, 2009

(54) Method and Apparatus for Generating a Test Plan Using a Statistical Test Approach

(76) Inventors: Robert D. O'Shea, Harvard, MA (US); Simon J. Hennin, Worcester, MA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/266,773

(22) Filed: Nov. 7, 2008

Related U.S. Application Data
(60) Provisional application No. 60/986,047, filed on Nov. 7, 2007.

(51) Int. Cl. G06F 19/00

(52) U.S. Cl. 702/108

(57) ABSTRACT

A process for generating a set of tests for a system includes identifying a plurality of factors to use in a design of experiments (DOE) test, using each of the plurality of factors in the DOE, identifying, through the DOE testing, one or more factors which have a significant effect an output of the system, including only the one or more factors in a Combinatorial design methodology (CDM) and generating a first test matrix based upon the CDM using the DOE inputs. The unique part of the process is then adding interactions of order greater than 2-way, as identified by the DOE, to the CDM matrix thus creating an optimized set of test cases. By using the sensitivity output of the DOE as an input to the final test matrix from the CDM, an affordable yet comprehensive test approach is provided.

### RELATED APPLICATIONS

This application claims the benefit of U.S. Provisional Application No. 60/986,047 filed Nov. 7, 2007 under 35 U.S.C. §119(e) which application is hereby incorporated herein by reference in its entirety.

### FIELD OF THE INVENTION

This invention relates to system testing and more particularly to a system and technique for generating a test plan.

### BACKGROUND OF THE INVENTION

As is known in the art, prior to commercial release of a product or system, there exists a need to test the system to ensure its proper operation in a variety of different operating environments. Some systems, however, have such a wide range of possible test scenarios that it becomes relatively difficult to thoroughly test the systems. For example, some systems are subject to scenarios comprised of many independent factors (i.e. factors which do not have a cause and effect relationship with each other). The independent factors can be taken in different combinations so as to make the number of possible combinations of scenarios so large as to make it impractical to test all of the different combinations of scenarios. This problem is exacerbated by the fact that certain unknown combinations of the independent factors can negatively affect system performance by an amount which results in an undesirable level of system performance (even to the point of the system failing to operate at an acceptable level). Conversely, in some applications, there may be some combination of independent factors which are not important (i.e. they do not have any significant impact on system performance), but system users are not certain which combinations fall into that category.

Testing all possible combinations and permutations of such independent variables can be a time-consuming task and can also be very expensive in terms of money, processing resources and processing time. Furthermore, sometimes it is necessary to perform some testing at a deployment site and it may be difficult or impractical to access a deployment site for a period of time required to perform extensive on-site testing.

Perimeter defense systems are one example of a system in which multiple independent factors such as weather, lighting, temperature, landscape and sensor characteristics have thousands of possible combinations. To meet a required performance level for system detection and false alarm rates, it is necessary to vary the values of the factors which in turn results in a need for a large number tests. The cost and time needed to carry out testing on such a system is prohibitive. Thus, it is difficult to test a perimeter defense system in a way which ensures that the system will operate as desired over a wide range of scenarios.

Most of the time, both the system user (e.g. a customer) and the system supplier (e.g. a contractor) recognize that there is not enough time or resources to test all possible scenarios (i.e. all possible combinations of different factors) under which the system must operate. Often, good judgment and negotiation between the system user and the system supplier is used to develop a mutually agreed upon list of test conditions. One approach used to provide a set of test scenarios is the so-called Combinatorial Design Methodology (CDM) also known as High Throughput Testing (HTT). In this approach, a number of factors are considered in a statistical analysis to arrive at a proposed set of test scenarios. The conventional CDM approach, however, only captures two-way interactions.

### SUMMARY OF THE INVENTION

In accordance with the concepts and techniques described herein, a process for generating a set of tests for a system includes identifying a plurality of factors to use in a design of experiments (a/k/a Designed Experiments) (DOE) test; using each of the plurality of factors in the DOE; identifying, through the DOE testing, one or more factors which have a significant effect on output of the system; including only the one or more factors in a combinatorial design methodology (CDM); and using the factors identified as significant in the DOE as inputs to the CDM to generate a first test matrix.

With this particular arrangement, a process for generating a plurality of tests which capture substantially all (or in some cases, all) of the conditions to which a system is sensitive is provided. Each test includes a combination of factors or conditions. By combining the DOE and CDM techniques, selected ones of a plurality of possible tests are identified for inclusion in the test matrix. In this manner, a relatively small number of tests (compared with the total number of tests possible) are identified which test substantially all (or in some cases, all) of the conditions to which a system is sensitive.

The technique described herein thus utilizes a combination of DOE and CDM processes to generate the test combinations. The tests to include in the test matrix are thus selected using a statistical process (based upon DOE and CDM). Using the technique described herein, the number of test combinations designated to test a particular system or process is less than the number of test combinations which would otherwise be required using conventional test generation techniques. The process also provides a statistically based confidence level. In the DOE, the independent factors (or independent variables) are those factors having values controlled or selected by an experimenter to determine their relationship to an observed phenomenon (i.e. the dependent variable or system characteristic being observed). In such a set of experiments, an attempt is made to find evidence that the values of the independent factors determine the values of the system characteristic(s) being observed (i.e. that system characteristic or dependent variable which is being measured). The independent factors can be changed as required.

In accordance with a further aspect of the concepts and techniques described herein, a process includes using one or more designed experiments to provide sensitivity analysis and to look for two or more independent factors which, when combined, become significant to one or more system outputs being measured. In one embodiment, a product marketed by Air Academy Associates, Texas under the brand name DOE PRO computes a P(2) tail value for each of the factors. In one embodiment, each factor having a P(2) tail value of 0.05 or less is considered to be significant. In other embodiments other P(2) tail values (i.e. values greater than or less than 0.05) may be used to distinguish or define factors considered to be significant. It should, of course, be understood that other techniques may also be used to identify significant factors. For example, in general overview, DOE generates an equation which models a cause and effect relationship between factors and an output under consideration. Thus, one technique to identify factors considered to be significant would be to simply select the factors having the largest coefficients in the equation.

It should also be understood that, to the extent that other techniques now existing or techniques as yet unknown can be used to determine significant factors (either analytically or empirically) such techniques can be used in place of or in combination with the DOE technique.

In general, those of ordinary skill in the art will appreciate other techniques which may be used to find significant factors from a designed experiment.

The effects of the certain combinations of independent factors (or variables) are recorded. A regression analysis is used to rank by significance the factors and any significant interactions between factors (significant interactions may also be identified by computing a DOE PRO P(2) tail as described above). Next, the most significant factors are included in a Combinatorial Design Methodology (CDM). The CDM identifies all two-way interactions between the significant factors in a CDM test matrix. Any interactions that involve more than two (2) factors can be (and preferably are) added to the CDM test matrix. A required sample size is then calculated based upon a probability and confidence level requirement and nature of the test. Standard techniques such as the bi-nominal curve may be used to determine sample size. If the CDM test matrix does not by itself meet a desired (or required) sample size, the test matrix is repeated enough times to meet the sample size desired (or required) by the program.

By first using a DOE approach to understand the relative contribution of the many factors to which the system will be subject and then testing a substantially optimized and substantially minimized test matrix of the most significant factors as determined by using the CDM, field test disruptions at the test site are reduced (and in some case may be minimized) and statistically based confidence that the system meets desired operational requirements is obtained.

With this particular arrangement, a method of combining a sample size calculation and Design of Experiments (DOE) with a Combinatorial Design Methodology (CDM) to provide an affordable test matrix that is comprehensive and based upon statistics is provided. The result is identification of reduced (and in some cases minimum) number of test combinations which capture all or substantially all of the conditions to which system performance is sensitive. The tests are identified using a statistical technique and provide a statistically based confidence level. Thus, the number of tests identified is reduced to a number below the maximum possible number of tests which could be performed if each possible test were performed.

One aspect described herein is the use of DOEs to generate inputs to a CDM. In particular, using a sensitivity output of the DOE to identify significant factors to be used as inputs to a final test matrix from the CDM results in the generation of a comprehensive test matrix. Since the number of tests included in the test matrix is less that the number of tests which would be included using conventional techniques, the approach described herein results in a testing program that is less expensive (and thus more affordable) than testing programs which are generated using conventional techniques.

### BRIEF DESCRIPTION OF THE DRAWINGS

The foregoing features of this invention, as well as the invention itself, may be more fully understood from the following description of the drawings in which:

FIG. 1 is a block diagram of a system for generating a set of tests for testing a complex system;

FIG. 2 is a flow diagram of a process for generating a set of tests for testing a complex system; FIG. 3 is an exemplary Cause and Effect Diagram for a sensor;

FIG. 3A is an alternate representation of the exemplary Sensor Cause and Effect Diagram of FIG. 3;

FIG. 4 is an exemplary Fractional Factorial Design of Experiments (DOE) matrix;

FIG. 5 is an exemplary a bar chart which plots a relative sensitivity of each factor in a DOE matrix;

FIG. 5A is an exemplary surface plot which illustrates the significance of temperature and wind with respect to false alarm rate (FAR);

FIG. 6 is an exemplary Cause and Effect Diagram for a Pre-Acceptance Test;

FIG. 6A is an alternate representation of the exemplary Cause and Effect Diagram of FIG. 6

FIG. 7 is an exemplary Pre-Acceptance Test DOE matrix;

FIG. 8 is a diagram of an exemplary zone classification methodology for an airport zone including example zone characteristics;

FIG. 9 is an exemplary table of tests showing factors and levels for a field acceptance test (FLDAT);

FIG. 10 is an exemplary FLDAT Combinatorial Design Matrix;

FIG. 11 is a plot of sample size vs. an acceptable number of failures for a pair of exemplary binomial (pass/fail) sample size calculations; and

FIG. 12 is a block diagram of a computer or processing system on which the processes described herein may be implemented.

### DETAILED DESCRIPTION OF THE PREFERRED EMBODIMENTS

Experimental design or deign of experiments (DOE) has been defined as an approach which utilizes purposeful changes of inputs (factors) to a process (or activity or system) in order to observe corresponding changes in outputs (or responses) of the process (or activity or system). The process (or activity or system) is defined as some combination of machines, materials, methods, people, environment, and measurement which, when used together, perform a service, produce a product, or perform a task. Thus, DOE is a scientific approach which allows a researcher to gain knowledge in order to better understand a process and to determine how inputs to a system (including a process) affect the system response(s) or output(s).

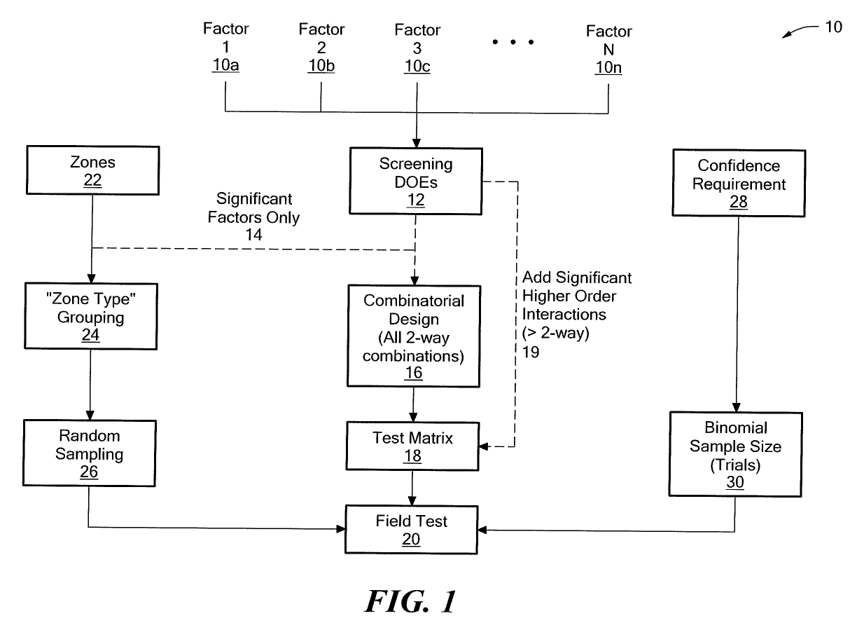

Referring now to FIG. 1, a plurality of factors 1-N and identified with reference numerals 10a-10N, generally denoted 10, are used to provide a design of experiments (DOE) test matrix 12. In this exemplary embodiment, a screening DOE 12 is used although those of ordinary skill in the art should appreciate that any type of DOE may also be used. The screening DOE tests are carried out to identify one or more significant factors 14. In one embodiment, a software program marketed by Air Academy Associates, Texas under the brand name DOE PRO computes a P(2) tail value for each of the factors. In one embodiment, each factor having a P(2) tail value of 0.05 or less is considered to be significant.

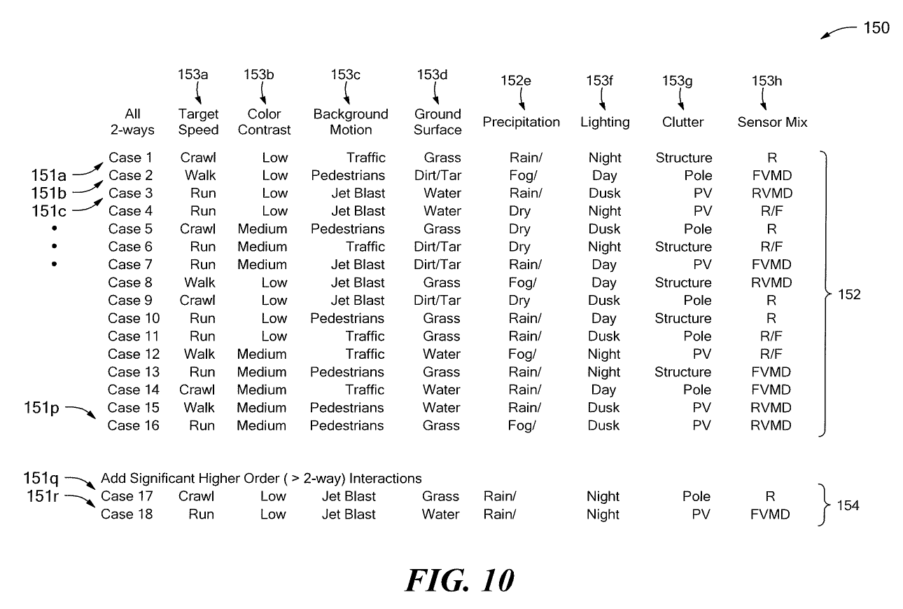

Each of the significant factors 14 are provided to a combinatorial design methodology (CDM) 16. The CDM is used to identify all 2-way interactions between significant factors without consideration of higher order factors and provides a matrix of test cases as shown in block 18. As indicated by reference numeral 19 and as will be described in further detail below in conjunction with FIG. 10, once the CDM matrix of test cases is initially established, test cases involving significant higher order interactions are then added to the CDM matrix of test cases. Using the DOE to generate factors for input to a CDM thus results in a test matrix 18 having optimized or substantially optimized test cases. Optimizing tests is the art of creating a test that effectively captures failures and is at the same time cost and time effective. The DOE screening ensures that the tests are based upon the most significant factors which could cause failure. The CDM then produces a matrix of test cases 18 that is very efficient and practical. This approach reduces the overall number of tests needed and thus, in turn, reduces the number of disruptions at a test site. At the same time, this technique provides a statistically based set of test cases. Utilizing a statistically based set of test cases establishes a desired level of confidence that the system or process being tested meets desired requirements (e.g. desired probability and confidence level requirements).

The test matrix is then used to conduct field tests 20 while also taking into factors such as zone factors 22, 24, (e.g. zone and zone type grouping), sampling requirements 26, confidence requirements 28 and required sample sizes 30.

The significant characteristics identified in the screening DOE 12 are also used to identify one or more significant zone characteristics out of a plurality of possible zones as shown in block 22. Then, as shown in block 24 all detection zones at each test site are categorized into a set of zone types. In preferred embodiments, the detection zones at each test site are categorized into a minimum set of zone types. The same zone type definition can be used across all test sites, but it should be appreciated that some test sites will not have all zone types. It should also be appreciated that the quantity of zones in each zone type will also vary by site. Unique zones can be given their own zone type.

As shown in block 26, zones of a particular type are randomly selected as part of the field testing 20. The zone types are randomly selected while varying all of the conditions according to the combinatorial design matrix 18.

In some embodiments, a requirement for the critical parameter includes a confidence level which requires a minimum sample size or trials. Thus, prior to conducting the field tests 20, confidence requirements 28 and binomial sample sizes or trials 30 are selected.

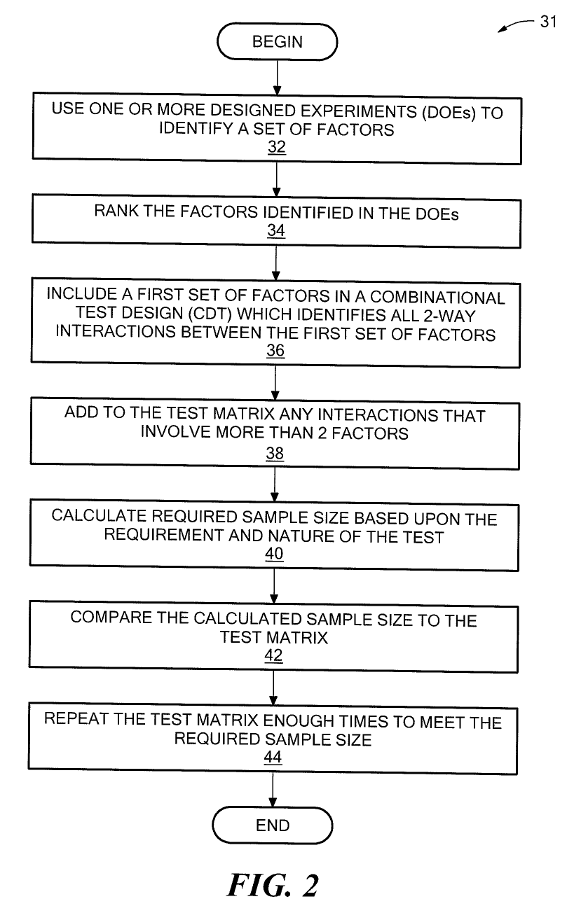

Referring now to FIG. 2, a flow diagram illustrating an exemplary process 31 for providing a test matrix for a system begins in processing block 32 by identifying a plurality of factors to be used in a set of screening design of experiments (DOEs). The screening DOEs are used to identify a set of factors which impact a performance characteristic (e.g. an output characteristic) of the system to be tested.

As shown in block 34, the factors are ranked such that significant factors are identified. That is, the DOE tests reveal those factors having a significant impact on the system performance characteristic being measured. Such factors are referred to herein as significant factors. The ranking is optional as any techniques can be used to identify significant factors.

After identifying significant factors, those factors are then included as a first set of factors to be used as inputs to a combinatorial design methodology (CDM) as shown in process block 36. The CDM identifies all two-way interactions between the first set of factors and provides a CDM test matrix which includes the number of test cases required to test the system.

Additionally, any interactions of significance which involve more than two factors are added to the CDM test matrix as shown in processing block 38. Once a CDM test matrix is established, it is necessary to calculate a required sample size based upon probability and confidence level requirements and the nature of the test as shown in processing block 40.

A comparison is then made between the calculated sample size and the test matrix as shown in block 42.

As shown in processing block 44, the test matrix is repeated to meet the required sample size. If for example, the CDM matrix results in six test cases (scenarios) and the required sample size is forty-five trials to meet a pre-selected confidence level, the six test cases would be repeated eight times thereby resulting in forty-eight test trials made up of a mixture of six unique test scenarios.

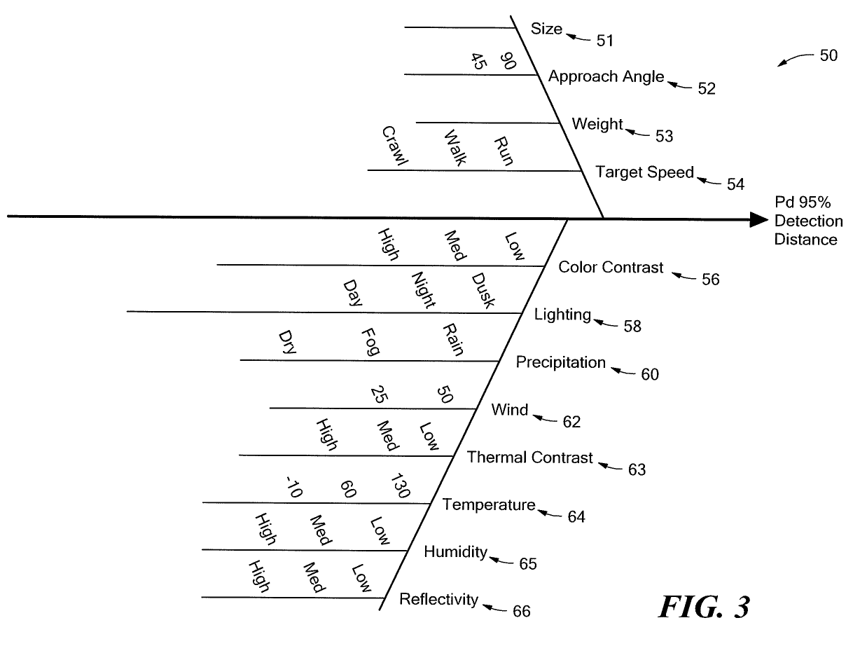

FIGS. 3-11 describe an exemplary embodiment related to the testing of a critical parameter of a perimeter intrusion detection system (PIDS). In particular FIGS. 3-11 describe a system and process to generate a test matrix for use in an acceptance test plan (ATP) for a PIDS. The critical parameter of the PID is identified as probability of detection (Pd) since it is believed that this parameter largely determines the overall performance of the PID system. It should be appreciated that systems under test (in this case a PID) may have more than one critical parameter. In this example only a single critical parameter had been identified in order to promote clarity in the description and explanation of the more general concepts described and claimed herein.

Reference is also made herein to the PID system being comprised of one or more sensors and being disposed at an airport so that the PIDS acts as an airport security system. Thus, in this example, the test site is an airport.

It should, however, be appreciated that while reference is made herein to a PID system disposed at an airport, the techniques described herein find use in a number of applications including but not limited to an airport security system. Examples could include but are not limited to: secure entry systems that need to be tested for different combinations of forgery techniques, redundancy, staffing and simultaneous transactions; electronic systems tested at various frequencies, data rates, power levels, operational states and environmentally induced levels of performance loss; software testing where it is impractical to test all of the possible ways the software operates and how it will be used by the consumer; testing of the positive and negative effects of possible medical cures that are based on the combination of the multitude of drug variables with many human and environmental factors; and electronic perimeter systems that are used to defend computer assets against cyber intrusions or attacks.

It should also be appreciated that the system and technique described herein are not limited to use with a PID system. Rather, reference herein to a PID system is done to promote clarity and understanding in the text and should not be construed as limiting. It should be appreciated that the system and processes described herein to generate a test plan may be applied to a wide range of systems, products and/or processes.

In one embodiment directed toward deployment of the PID system in an airport application, a “planned intruder” is defined as a planned target having size, speed and position attributes which result in a valid intrusion scenario. The value of probability of detection (Pd) by a PID sensor is measured as the ratio of detected and classified planned intruders to the quantity of planned intruders introduced. Unplanned intruders are excluded from the probability of detection calculation because the total number of unplanned intruders (i.e. including those for which no alarm was raised) will be unknown. False and nuisance alarms are also excluded from the probability of detection calculation.

$$Pd = \frac{( Alarm Count for Planned Intruders )}{( Planned Intruders )}$$

Following the process flow in FIG. 1, the first step is to identify possible factors (e.g. corresponding to factors 10 in FIG. 1) that affect detection by a PID sensor (i.e. that affect the ability of a PID sensors to “see” or detect a target).

Referring now to FIG. 3, in one embodiment, a so-called fishbone cause and effect technique, illustrated as diagram 50 in FIG. 3, can be used to identify independent factors (i.e. factors which are independent from each other; that is, a change in one factor will have no impact on any other factor). The independent factors in the diagram 50 are tested to determine their significance to a PIDS sensor.

In the example being presently described (i.e. a PIDS disposed at an airport), a plurality of independent factors 51-66 are shown. It should be appreciated that there are many possible independent factors and to provide clarity in the description and the drawing, not all of the possible independent factors are shown in the fishbone diagram 50. For example, fence rigidity and fence height could be two other independent factors.

It should also be appreciated that independent factors 51-54 each relate to the target while factors 56-66 each relate to the environment in which the PIDS is disposed.

In this example where a sensor is being tested, manufacturer sensor performance data is acquired where available and all existing and available sensor empirical data is collected in an attempt to understand sensor sensitivity. Any gaps in the data may be filled through experimentation. Manufacture data may or may not be a factor. For example, if the sensor manufacturer specified that the sensor can withstand winds up to 200 mp with no affect, and it is know that the PIDS will not be required to operate in winds over 200 mph, then wind could be eliminated as a factor to consider simply based upon the manufacturer data or other data.

Given a set of factors, the next step is to determine the levels of each factor that cover reasonable boundaries of specified conditions. For example, when considering lighting as a factor, it may be sufficient to use two levels of lighting (e.g. Day to Night). However, if dusk/dawn lighting is believed to cause issues that day conditions or night conditions would not cause, then three or four levels of lighting may be used. The decision of how many levels of a particular factor are required for a particular application will typically be guided by application specific requirements. For example, the number of levels to select for a factor such as wind speed or maximum wind speed may vary depending upon the particular application.

In the fishbone diagram of FIG. 3, for example, the factors target speed 54, color contrast 56 lighting 58, precipitation 60, thermal contrast 63, temperature 64, humidity 65 and reflectivity 66 have all been assigned three levels (e.g. color contrast has levels high, medium, low; target speed has levels run, walk, crawl; and temperature has levels −10° F., 60° F. and 130° F.). Approach angle 52 and wind 62, on the other hand, only have two levels each (i.e. approach angle has levels 45° and 90°; and wind has levels 25 mph and 50 mph).

Out of all of the factors considered, it is necessary to determine those factors which are most significant with respect to sensor performance (i.e. it is necessary to determine those factors which have the greatest impact on sensor performance).

Referring briefly to FIG. 3A, in which like elements of FIG. 3 are provided having like reference designations, fishbone diagram 70 corresponds to an alternate representation of substantially the same factors and levels described above in conjunction with fishbone diagram 50 (FIG. 3).

In fishbone diagram 70, the factors 52-64 are grouped by categories. The exemplary categories shown in FIG. 3A are contrast 72, target characteristics 74 and environment 76. Other representations of the factors and levels (and optionally the categories) are, of course, also possible and can also be used to identify independent factors that will be tested.

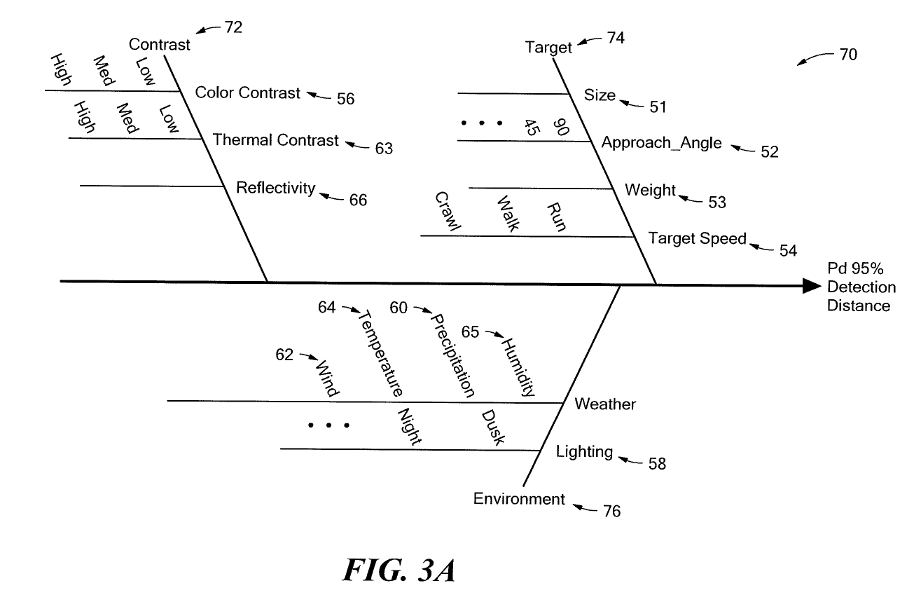

FIG. 4 shows one example DOE matrix 80 based upon the causes identified in FIG. 3. DOE matrix 80 includes 27 rows designated as 82a-82aa and 9 columns designated as 84a-84j. Each of the columns 84b-84h represent a factor (target, contrast, approach angle, precipitation, wind and lighting, respectively). It should be noted that column 84b corresponds to target mode of movement while columns 84c-84h relate to environmental conditions. It should also be noted that like modes of target movement are grouped in consecutive rows—i.e. rows 82a-82i correspond to a run mode of target movement, rows 82j-82r correspond to a walk mode of target movement, and rows 82s-82aa correspond to a crawl mode of target movement.

It should be appreciated that while two to three levels for each factor have been used in this example, in other scenarios more or fewer levels could be used for each factor.

By applying the screening DOE process, the result is matrix 80 which includes twenty-seven (27) test conditions (i.e. each row 82a-82aa represents a test condition or case) which is a relatively small number of test conditions when compared to the six hundred forty eight (648) test cases that cover all combinations.

Column 84i and 84j hold the values from two trials of the 95% Pd Detection Distance measured for each PID sensor as an output for each of the test cases 82a-82aa of the DOE matrix 80. The Pd Detection Distance is defined as the distance at which a target is detected a minimum of 95% of the time. In one embodiment of a perimeter detection system which includes fence sensors, the fence sensors detect vibration (predominantly on contact). Thus, this distance measure will be the amount that the fence has been scaled or displaced prior to detection. One purpose of the matrix 80 is to establish a mathematical relationship between the factors and the sensor response.

Test combinations that have the common conditions that are most difficult to control can be grouped and executed. For example, test cases 1 and 25 in matrix 80 are both on a very cold day in the snow and thus can be tested together. To understand the variability of any one condition, the measurements in each set of conditions will be repeated at least two (2) times with elapsed time in between.

In addition to the designed experiment, additional tests with identical combinations can be added replacing certain factors in an attempt to find methods of simulating hard to control conditions. For example, optical filters can be used with cameras, attenuators with radars and dampers with the fence sensors to simulate snow and ice. A detection distance is determined and performance curves compared to the results in the real conditions to determine if the sensitivity is the same.

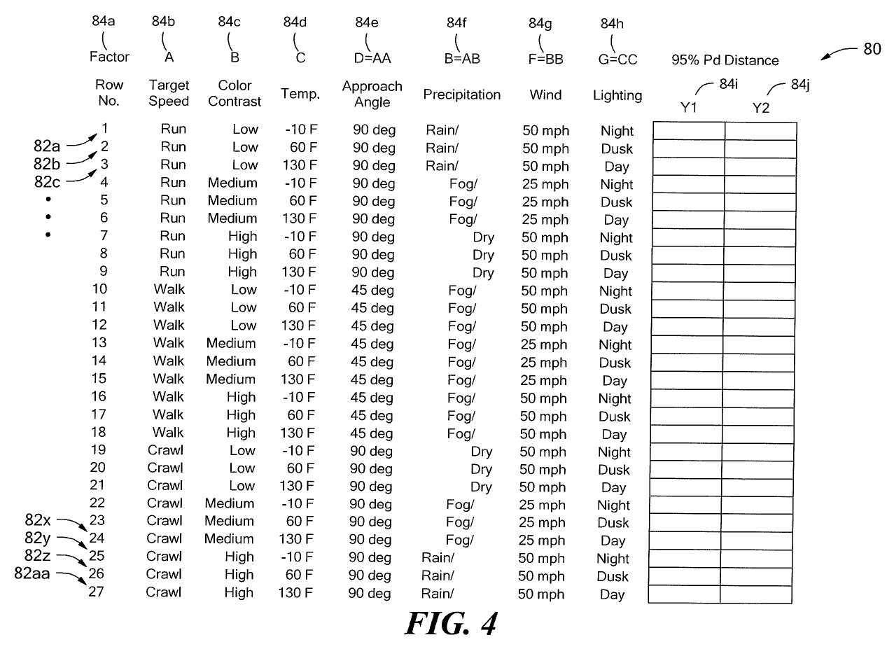

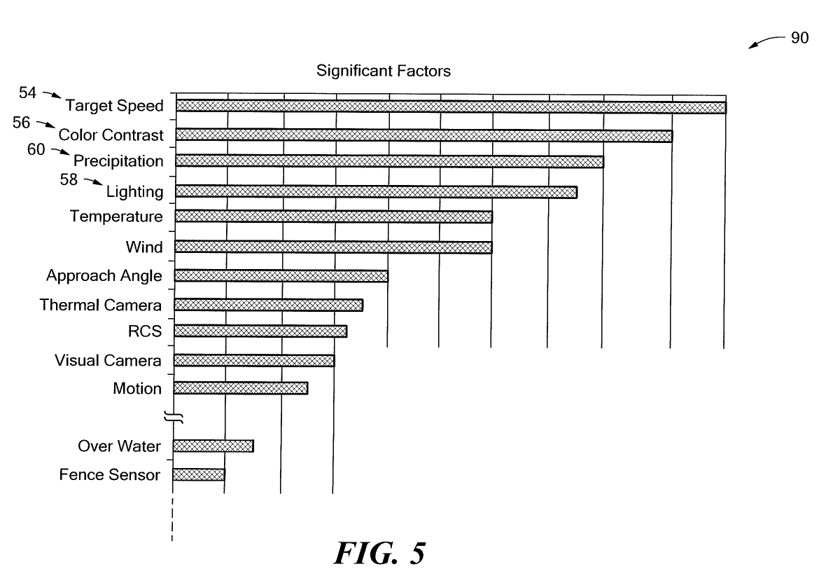

Referring now to FIG. 5, a bar chart 90 shows the results of completing the DOE matrix 80 (FIG. 4), statistically analyzing the results and extracting the relative sensitivity of each factor. Those of ordinary skill in the DOE art will appreciate how to analyze the data. In general, a multi-response regression analysis may be used.

In this example, target speed, color contrast, precipitation and lighting (i.e. elements 54, 56, 58, 60 in FIG. 3) are found to be the four most significant factors with respect to the sensor. Thus four significant sensor factors are found.

FIG. 5A is an example surface plot which illustrates the significance of two different factors (temperature and wind) with respect to false alarm rate (FAR) where FAR has a generally inverse relationship to probability of detection Pd.

With the information shown in FIG. 5 a search can be conducted for factors having similar sensitivity that could substitute for each other. This can be accomplished, for example, by examining the P(2) tail value for each factor or by any other technique now known or unknown, to those of ordinary skill in the art. For example, if a certain level of wind has the same effect as a particular range of approach angles, future test combinations with a certain level of wind can be accomplished using a certain range of approach angles. Once this type of analysis (e.g. a sensitivity analysis or other analysis to evaluate the factors) is complete, the most significant factors and interactions can be identified for use in further tests (e.g. a Pre-Acceptance Test or other PID or PID sensor tests).

The test process for one or more sensors in a PID system may thus be summarized as follows: determine the independent variables (factors) and their possible conditions/settings (levels); try to make each factor have 2-3 levels (the DOE is more complicated if 4 levels are introduced and is easiest when all factors have the same number of levels); eliminate any factors previously proven insignificant by manufacturer's data or previous empirical results; create a designed experiment (DOE); execute each experimental combination; record detection distance and complete sensitivity analysis; and select significant factors and interactions to be brought forward to the CDM.

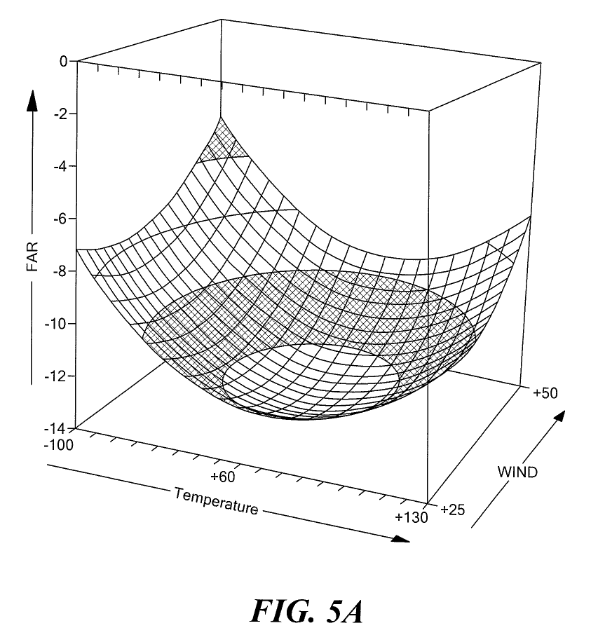

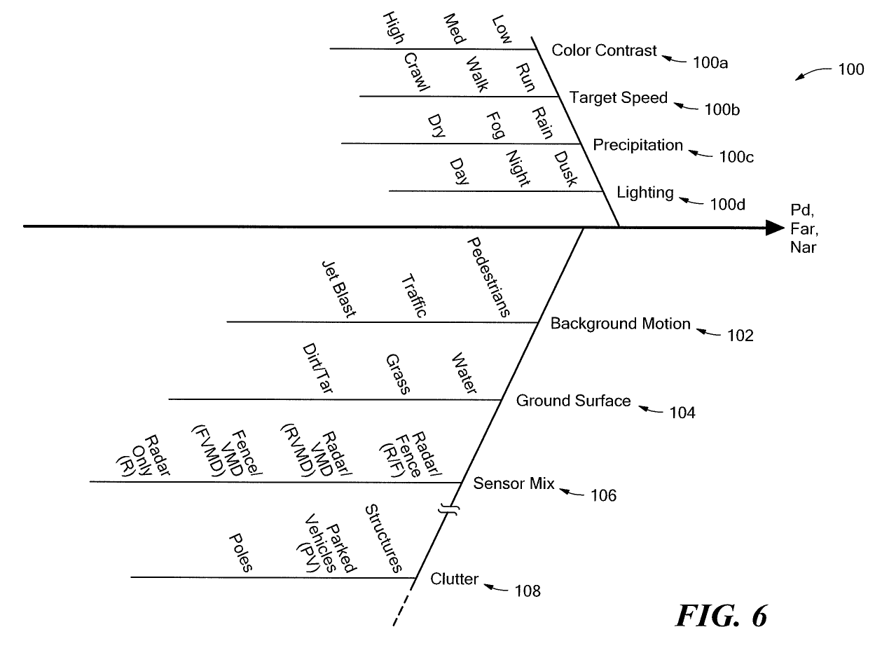

Referring now to FIG. 6, a fishbone diagram 100 includes a plurality of exemplary factors 100-108 being considered for a Pre-Acceptance Test (PAT) zone sensitivity analysis. It should be appreciated that fishbone diagram 100 include a mix of both sensor factors and so-called zone factors (or zone effects). The sensor factors in fishbone diagram 100 are color contrast 100a, target speed 100b, precipitation 100c and lighting 100d. It should be appreciated that these are the same four factors which were identified as significant sensor factors in conjunction with FIGS. 3-5 (i.e. factors 54-60 in FIGS. 3-5).

The exemplary zone factors shown in fishbone diagram 100 are background motion 102, ground surface 104, sensor mix 106 and clutter 108. Each of the zone factors 102-108 has levels. For example, sensor mix 106 has the following four levels: (1) Radar/Fence (R/F); (2) Radar VMD (RVMD); (3) Fence VMD (FVMD) and (4) Radar only (R). Other zone factors could, of course, also be added to fishbone diagram 100. Thus, zone effects such as background motion 102, ground surface 104, sensor mix 106 and clutter 108 are combined with the most significant factors (i.e. color contrast 100a, target speed 100b, precipitation 100c and lighting 100d) from the sensor sensitivity analysis discussed above in conjunction with FIGS. 3-5. The factors 100-108 each have an effect on the values of the Pd, the FAR and the nuisance alarm rate (NAR). It should be appreciated that the particular factors (or causes) to use in any particular application (e.g. applications other than PIDS disposed as airports), however, may be refined as a test design proceeds for a particular application.

Referring briefly to FIG. 6A, in which like elements of FIG. 6 are provided having like reference designations, fishbone diagram 109 corresponds to an alternate representation of substantially the same factors and levels described above in conjunction with fishbone diagram 100 (FIG. 6). Other representations of the factors and levels (and optionally categories) are, of course, also possible and can also be used to identify factors that will be tested.

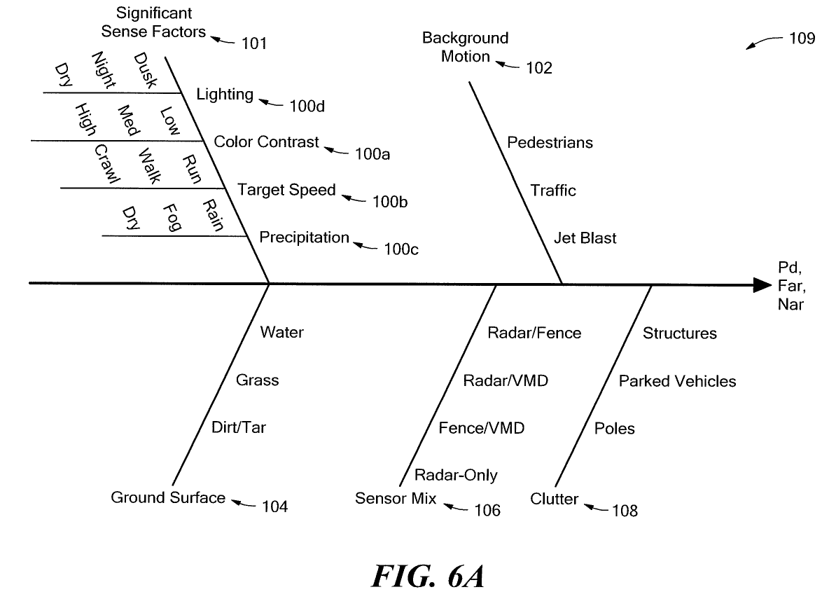

Referring now to FIG. 7, an example screening DOE matrix 110 for the measurement of Pd includes factors set forth in columns 112b-112i and twenty-seven test conditions set forth in rows 114a-114aa. It should be appreciated that the factors set forth columns 112b-112e (identified as group 116) correspond to the significant sensor factors identified as described above in conjunction with FIGS. 3-5. Columns 112f-112i (identified as group 118), on the other hand, correspond to zone factors discussed above in conjunction with FIGS. 6 and 6A. It should be appreciated that factors 118 cannot yet be referred to as significant zone factors since they have not as yet been determined to be significant.

The use of a screening DOE (as show, for example in FIG. 1 at element 12) helps reduce the number of tests in the field by identifying factors that can be eliminated. The twenty-seven test conditions 114a-114aa shown in matrix 110 are a relatively small number of test conditions when compared to the 1944 test cases which are required to cover all combinations.

The measurement results for each test 114a-114aa from the screening DOE matrix 110 are binary in nature. That is, the system either does or does not provide an alarm signal and quantities of alarms can be recorded in columns 112j, 112k but not levels of Pd. In order to establish a mathematical relationship between the factors and the system response, each DOE combination is executed a predetermined number of times. In one embodiment, the particular number of times to execute each DOE combination should preferably be the number of times which yields a Pd measure for each combination to provide insight into Pd sensitivity. In one embodiment for the PIDS, each DOE combination is executed a minimum of ten times since this yields a Pd measure for each combination to provide insight into Pd sensitivity. For example, nine detections out of ten attempts for a certain combination of factors will give a 90% Pd for that combination.

Test combinations that have the common conditions that are most difficult to control can be grouped and executed. For example, the test cases in rows 114a-114c, 114j-114l and 114s-114u in matrix 110 of FIG. 7 can all be tested on days of heavy rain. Since the DOE includes factors that are zone characteristics, an attempt can be made to provide the similar characteristics at any available site (e.g. airport) zones or at a test facility. The following are a few possible techniques that could be used if necessary: (a) clutter can be provided by adding increasing quantities of parked vehicles, facade structures and boxes in the field of view of the sensors; (b) sensor positions, angles and distances to the assumed perimeter can be varied; (c) background motion can be provided by passing vehicles, pedestrians and man-made wind on trees from large industrial fans; and (d) ground surface variation can be provided using different materials in different areas.

A test process summary for Pd includes: identification of significant factors from a sensor test screening DOE; consideration of three (3) levels for those factors that are expected to interact with others; elimination of any factors that have been previously proven insignificant from previous tests or published literature; creation of a designed experiment (DOE); repeating each test combination a minimum of ten (10) trials; execution of each experimental combination and recordation of results (Pd) and complete zone sensitivity analysis.

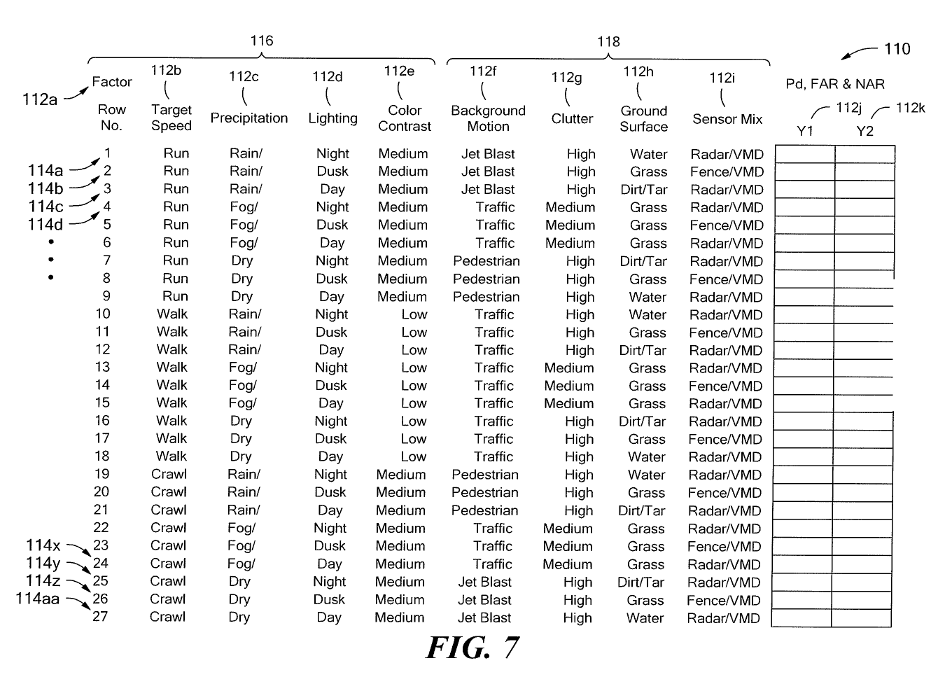

Referring now to FIG. 8, a zone classification methodology 130 for an airport having N zones 132a-132N, generally denoted 132, includes zone characteristics 134a-134d, generally denoted 134 and zone types 136a-136c, generally denoted 136. In the PID system airport example, to perform the zone classification, the airport drawings and first-hand knowledge of perimeter conditions obtained from site surveys are utilized. Each zone corresponds to a physical portion of the airport. For example, zone 1 may be a runway, zone 2 may be a water zone, etc. . . .

All detection zones 132 at each site (e.g. e.g. each airport) are categorized into a minimum set of zone types 136 using one or more of the significant zone characteristics 134 identified in a Screening DOE, (e.g. the screening DOE shown in FIG. 1, element 12). The same zone type definition can be used across all sites (e.g. airports), but some sites will not have all types (for example, some airports may not have any water zones). The quantity of zones in each zone type will also vary by site. Unique zones can be given their own zone type.

Significant zone characteristics are used to determine zone types 136a-136c and then all zones are classified into zone types (e.g. see FIG. 1 element 18b). In a PID system airport application, for example, all airport zones are classified into zone types. An airport zone might represent a defined linear distance of the airport border. A zone type is a group of these linear distances all sharing the same characteristics (i.e. chain link fence with fence sensors along the woods).

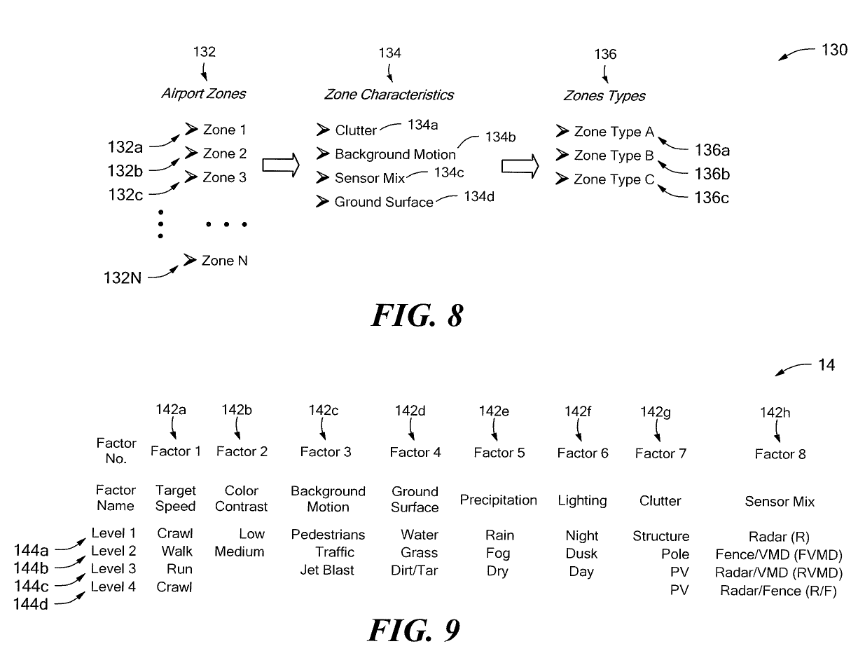

Referring now to FIG. 9, a matrix 140 includes eight factors set forth in columns 142a-142h and four tests set forth in rows 144a, 144d. The factors and levels in matrix 140 are those factors and levels found to be significant from sensor and zone screening DOEs. In this example eight factors are found. Four of the factors (target speed 142a, color contrast 142b, precipitation 142e and lighting 142f) are sensor factors and four of the factors (background motion 142c, ground surface 142d, clutter 142g and sensor mix 142h) are zone factors. It should be appreciated that if all eight factors and levels were tested in every possible combination, the test case matrix would include 3,888 runs. If, for example, 15 zone types are identified, the total number of runs would be 58,320.

Having identified the significant factors, these factors and levels are then used in a CDM (e.g. as shown in block 16 of FIG. 1) to generate a comprehensive test matrix for a field acceptance test (e.g. as shown in blocks 18, 20 of FIG. 1).

Referring now to FIG. 10, a comprehensive test matrix 150 generated using the significant factors and levels from FIG. 9 includes 18 test cases set forth in rows 151a-151r. Eight factors used in the tests 151a-151r are set forth in columns 153a-153h.

The comprehensive test matrix 150 comprises a two-way combinatorial design matrix portion 152 which includes sixteen (16) runs (i.e. rows 151a-151p) and a DOE portion 154 which includes two runs (i.e. rows 151q-151r). The DOE portion 154 adds significant higher order interactions (i.e. interactions greater than two-way interactions) to the test matrix 150. Thus, the combinatorial design test matrix significantly reduces the test time and disruptions at test sites (e.g. airports). The matrix 150 includes many 3-way, 4-way and greater interactions, but not all. Adding additional combinations found significant in the preceding DOEs and running enough replications to meet the required confidence levels provides a testing approach that is comprehensive and not random.

Thus, DOEs have been used to generate inputs to a CDM. The technique described herein can be used to generate a test matrix (such as matrix 150) which includes a CDM portion (e.g. portion 150) and a DOE portion (e.g. portion 152) which includes significant higher order interactions. In particular, using a sensitivity output of the DOE as an input to a final test matrix from the CDM results in the generation of the comprehensive test matrix 150. Since the number of tests included in the test matrix is less that the number of tests which would be included using conventional techniques, the approach described herein results in a testing program that is less expensive (and thus more affordable) and which can be completed more rapidly than testing programs which are generated using conventional techniques.

Referring again to the example of the PID system deployed at an airport, the field acceptance test (FLDAT) at an airport needs to consider all significant factors and levels discovered in the sensor and zone sensitivity analyses (e.g. as discussed in conjunction with FIGS. 3-9). As described herein, this was accomplished via a statistical approach which used a combination of DOE and Combinatorial Design methodologies. The combinatorial design methodology (CDM) identifies all 2-way combinations of the factors and levels to be tested (see, e.g. element 16 in FIG. 1). In this approach, all two-way interactions of factors were covered by a test matrix (e.g. test matrix 110 discussed in FIG. 7) and due to the large number of factors, many three and four way interactions also. Any significant 3-way, 4-way or greater interactions found in the sensor and zone screening DOEs were then added. The test cases in the matrix can be performed and repeated in each zone type until a desired confidence level is met.

It should be appreciated that constraints can be added to eliminate combinations that are physically or practically impossible. If available, previous field test results can also be used to eliminate combinations from the matrix to reduce cycle time and cost

Thus, as shown in FIG. 10, two test cases (#17 and #18) that represent examples of higher order (greater than 2) interactions have been added to the matrix 150. The result is a set of substantially optimized test cases (e.g. as shown in FIG. 1, block 18).

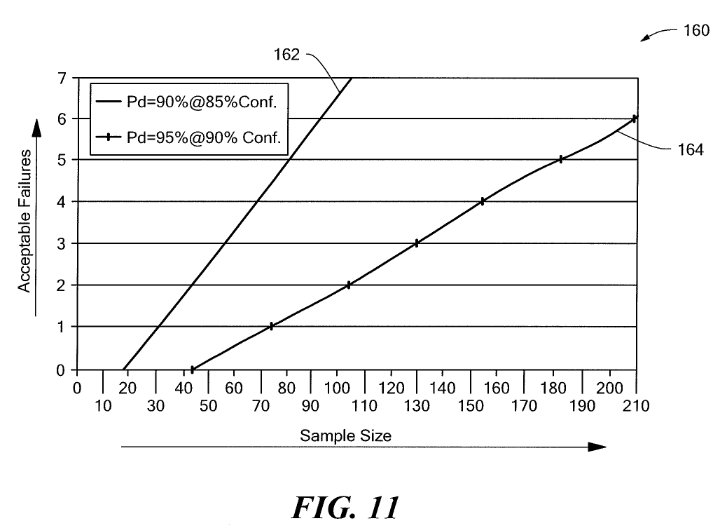

Referring now to FIG. 11, a plot 160 of sample size vs. acceptable failures shows the relationship between the quantity of acceptable missed targets and the planned intrusion sample size. Curve 162 corresponds to a 90% probability of detection (Pd) with an 85% confidence level. Thus, to achieve this metric would require 0 failures in a sample size of 19, 1 failure in a sample size of 31, 2 failures in a sample size of 45 and so on.

Similarly, curve 162 corresponds to a 95% probability of detection with a 90% confidence level. Thus, to achieve this metric, the acceptable failures would be 0 in a sample size of 45, 1 failure in a sample size of 76, 2 failures in a sample size of 105 and so on.

Thus, the requirement for Pd includes a confidence level which requires a minimum sample size or trials (e.g. as described in FIG. 1, block 30). The number of acceptable missed targets per planned intrusions can be calculated using a binomial curve. In one embodiment, the approach is to test to this sample size schedule in each zone type at randomly selected zones of that type (e.g. as described above in conjunction with FIG. 1 element 18c) while varying all of the conditions according to the combinatorial design matrix. This is superior to claiming compliance by meeting the confidence level in only a few “chosen” scenarios and is far more practical and less disruptive than testing the minimum sample size in all test cases and zones. The combinatorial test matrix and any added higher order interaction cases can be repeated until an acceptable success rate is achieved. For example, if all intrusions are detected in 45 trials, the test will be successfully complete for that zone type. If not, the test matrix will be repeated in a failing zone type until the confidence level is achieved or until an agreed to maximum trial size is reached (in which case, corrections to the zone type will be made and the test started over). It is believed that this statistical approach is robust and provides confidence that the system works in all combinations of factors and zone types.

Test combinations that have common conditions and that are the most difficult to control (e.g. heavy rain) will be grouped and executed together. Also, taking advantage of the test conditions the same test cases will be executed in all zone types in order to maximize the efficiency of the FLDAT. Given successful results, one example statistical approach only has 675 tests (15 zone types*0 failures in 45 runs) in comparison to the 58,320 tests identified above.

A summary of the test process for Pd includes: identifying and agreeing with a designated authority (e.g. a Port Authority) on the significant factors and levels, conducting screening DOEs to determine significant factors; identifying and agreeing with the designated authority on constraints in combinations (factor levels that can not happen together); identifying and agreeing with the designated authority to eliminate any previously executed test cases; creating a combinatorial design test matrix using the DOE outputs; adding any significant higher order interactions greater than 2-way identified in the sensor and zone screening DOEs; sorting the test matrix into a minimum number of test conditions; executing each test combination in each zone type and recording results (Pd); repeating the test matrix until confidence level is reached in each zone type; and taking corrective action until the requirements are met in all zone types.

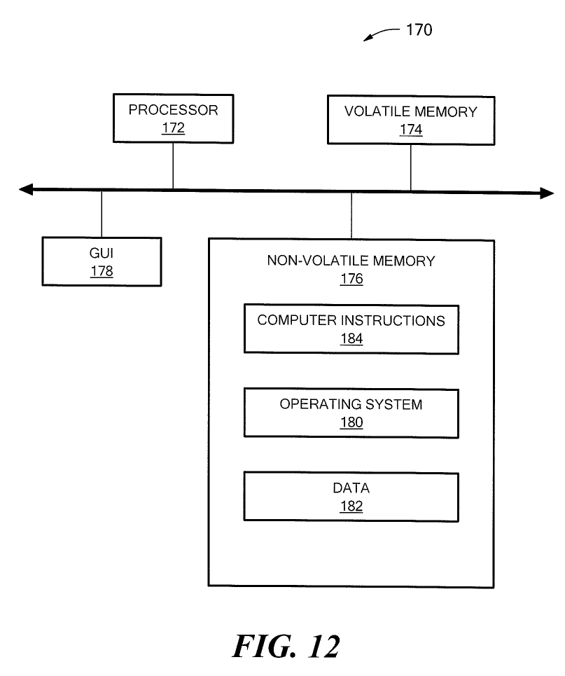

Referring now to FIG. 12 a computer or other processor 170 configured to compute a test matrix (e.g. test matrix 152 in FIG. 10) includes a processor 172, a volatile memory 174, a non-volatile memory 176 (e.g., Flash Memory) and a graphical user interface (GUI) 178. Non-volatile memory 176 stores operating system 180 and data 182 which include but is not limited to one or more of factors, zones, zone types, confidence requirements, sample size (e.g. as described above in conjunction with FIG. 1); categories and levels (e.g. as described above in conjunction with FIGS. 3 and 3A), and other parameters such combinatorial design information/factors/data (including but mot limited to information on two-way combinations as well as information on higher order interactions. Non-volatile memory 176 also stores computer instructions 184, which are executed by processor 172 out of the volatile memory 174 to perform processes (in whole or in part) such as that described in conjunction with FIG. 2. The GUI 178 may be used by a user to configure: factors, DOE settings (e.g. as allowed in DOE PRO, for example), combinatorial design settings, display settings (e.g. to display test matrices in various ways). Additional parameters that can be controlled by the user and not specifically enumerated here can also be controlled through the GUI.

It should be appreciated that processes described herein (e.g. as in conjunction with FIGS. 1 and 2) are not limited to use with the hardware and software of FIG. 12. Rather the processes described herein may find applicability in any computing or processing environment and with any type of machine that is capable of executing a computer program or computer or processor instructions. The processes described herein may be implemented in hardware, software, or a combination of the two. The processes described herein may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform one or more of the processes described herein and to generate output information described herein including but not limited to intermediate results or computations and including but not limited to DOE matrices and other DOE-related information, CDM matrices and other CDM-related information, and test matrices such as test matrix 150 described in conjunction with FIG. 11.

The system and techniques described herein may be implemented, at least in part, via a computer program product (i.e., a computer program tangibly embodied in an information carrier (e.g., in a machine-readable storage device or in a propagated signal, for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform processes described herein. The processes described herein may also be implemented as a machine-readable storage medium, configured with a computer program, where upon execution, instructions in the computer program cause the computer to operate in accordance with process.

The processes described herein are not limited to the specific embodiments described herein. For example, the processes are not limited to the specific processing order of FIGS. 1 and/or 2. Rather, any of the blocks of FIGS. 1 and/or 2 may be re-ordered, repeated, combined or removed, performed in parallel or in series, as necessary, to achieve the results set forth above.

While single DOEs and CDMs are shown and described in FIGS. 1 and 2, the techniques described herein may include any number of DOEs and CDMs which may be executed in series or parallel.

The system described herein is not limited to use with the hardware and software described above. The system may be implemented in digital electronic circuitry, or in computer hardware, firmware, software, or in combinations thereof.

Having described preferred embodiments of the invention it will now become apparent to those of ordinary skill in the art that other embodiments incorporating these concepts may be used. Accordingly, it is submitted that that the invention should not be limited to the described embodiments but rather should be limited only by the spirit and scope of the appended claims.

1. A process for generating a set of tests for a system, the process comprising:
identifying a plurality of factors to use in a design of experiments (DOE) test;
using each of the plurality of factors in the DOE;
identifying, through the DOE testing, one or more factors having a significant effect an output of the system;
including only the one or more factors in a combinatorial design methodology (CDM); and
generating a first test matrix based upon the CDM using the DOE inputs.

2. The process of claim 1 further comprising adding one or more tests to the first test matrix wherein each of the one or more tests includes a combination of two or more additional significant factors not included in the first test matrix.

3. The process of claim 2 wherein the DOE corresponds to a screening DOE.

4. The process of claim 3 wherein the screening DOE corresponds to a fractional factorial screening DOE.

5. A process for designing a set of tests for a sensor for use in a perimeter intrusion detection system, the process comprising:
(a) determining a plurality of independent factors;
(b) determining one or more possible levels for each of the plurality of independent factors;
(c) assigning at least one level to each of the independent factors;
(d) eliminating factors that have been previously proven insignificant by at least one of: manufacturer's data; or an empirical result;
(e) generating a designed experiment (DOE) which includes a plurality of experimental combinations;
(f) executing each of the plurality of experimental combinations;
(g) recording one or more sensor output characteristic for each of the plurality of experimental combinations;
(h) performing a regression analysis on the results of (g) to provide a relationship between the factors included in the experimental combinations and each of the one or more sensor output characteristics;
(i) using the results of (h) to complete a sensitivity analysis to rank the significance of the factors and interactions;
(j) selecting significant factors and interactions based upon a P(2) tail value; and
(k) using the selected significant factors and interactions as input to a combinatorial design method (CDM).

6. The process of claim 5 wherein recording a sensor output characteristic for each of the plurality of experimental combinations comprises recording a sensor detection distance for each of the plurality of experimental combinations.

7. The process of claim 5 wherein assigning at least one level to each of the independent factors comprises assigning three or less levels to each of the independent factors.

8. The process of claim 5 wherein assigning at least one level to each of the independent factors comprises assigning three or less levels to at least some of the independent factors.

9. A process for designing a set of tests for a system, the process comprising:
using one or more designed experiments (DOEs) to identify one or more factors which affect an output of the system;
including only the one or more factors in a Combinatorial Design Method (CDM) wherein the CDM identifies all two-way interactions between the factors provided thereto from the DOEs;
generating a first test matrix based upon the CDM and the DOE inputs provided thereto; and
adding one or more tests to the first test matrix wherein each of the one or more tests includes a combination of two or more additional significant factors not included in the first test matrix.

10. A process comprising:
identifying a plurality of independent variables;
using one or more designed experiments to provide sensitivity analysis and to look for interactions that involve more than two independent variables;
recording the interactions;
ranking the interactions by significance to a measured characteristic of the system;
including the most significant factors in a Combinatorial Design Method (CDM) which identifies all two-way interactions between variables;
identifying any interactions that involve more than two variables;
generating a CDM test matrix;
adding the interactions that involve more than two variables to the CDM test matrix; and
determining a required sample size based upon the requirement and nature of the test and compared to the test matrix.

11. The process of claim 10 wherein determining a required sample size comprises using a bi-nominal curve to determine a required sample size.

12. The process of claim 10 further comprising repeating the test matrix enough times to meet the sample size required by the program.

13. The process of claim 10 wherein ranking the interactions by significance to a measured characteristic of the system comprises ranking the interactions by significance to a measured output of the system.
